(19) United States
(12) Patent Application Publication
(10) Pub. No.: US 2003/0014642 A1
(43) Pub. Date: Jan. 16, 2003

(54) Security arrangement

(75) Inventors: Roy Martinsson, Frolunda (SE); Oskar Andler, Goteborg (SE)

Correspondence Address: HOWREY SIMON ARNOLD & WHITE LLP, 1299 PENNSYLVANIA AVE., NW, BOX 34, WASHINGTON, DC, 20004, US

(73) Assignee: FINGLOQ AB, Goteborg (SE)

(21) Appl. No.: 10/063,068

(22) Filed: Mar. 15, 2002

Related U.S. Application Data
(63) Continuation of application No. PCT/SE00/01811, filed on Sep. 18, 2000.
(60) Provisional application No. 60/154,395, filed on Sep. 17, 1999.

(30) Foreign Application Priority Data
May 5, 2000 (SE) 0001687-3

(51) Int. Cl. H04K 1/00

(52) U.S. Cl. 713/182

(57) ABSTRACT

The present invention relates to a security arrangement for ensuring access to a unit or information in a unit, mainly comprising a key unit and a lock unit. The key unit is arranged in a distance from the lock unit comprising an input unit and a communication unit. The identification of a user is performed in the key unit before the lock unit accepts locking/unlocking.

### CROSS REFERENCE TO RELATED APPLICATIONS

The present application is a continuation of International Application No. PCT/SE00/01811, filed Sep. 18, 2000 and published in English pursuant to PCT Article 21(2), now abandoned, and which claims priority to Swedish Application No. 0001687-3, filed May 5, 2000 and U.S. Provisional Application No. 60/154,395, filed Sep. 17, 1999.

### BACKGROUND OF INVENTION

1. Technical Field

The present invention relates to a security system for securing a unit or a set of information.

2. Background Information

The increasingly rapid development within the electronics area has resulted in more electrical apparatuses with reduced size and enhanced mobility. The mobility itself has lead to not only the apparatus itself, but also the information stored therein becoming appealing and attractive for thieves.

Known security arrangements provide locking using hardware or software in combination with a primary input signal. In the case of hardware lock, a first input unit is used, e.g., fingerprint input such as a biometric sensor, or a pin-code alone or in combination with an additional unit such as a smart-card or the like.

For a software lock, a verification software is typically used. This software insures that a correct input such as a pin-code, fingerprint, etc., is presented via an external input unit. Normally, the software is installed in a storage unit such as a hard disc, which is easily accessible.

U.S. Pat. No. 5,668,876 to Falk et al. (“the '876 patent”) describes an apparatus and method for authenticating a user in order that the user may use a service. The invention of the '876 patent accomplishes this by providing a modified pager that calculates a unique response code to a transmitted challenge code based on the challenge code, an input personal identification number, and an internal key. The response code is input to a simple terminal, such as a telephone and if the unique response code is acceptable, the user may access the desired service, such as cashless transactions or long distance phone service.

WO 00124554 describes the El-Gamal algorithm in a public key cryptosystem. Secret fresh random numbers are generated at a server and private keys of users, as encrypted with a symmetric algorithm by using individual user identifying keys determined by hashing the users” respective pass phrases or biometric information (fingerprint, voiceprint, retina scan, or face scan) are maintained in a store accessible to the server, and the fresh random numbers and encrypted private keys are transmitted to the user equipment when needed via a network which is not secure.

In order to prevent an attacker from discovering the random numbers or employing formerly used random numbers in a block replay attack, an interchange in the nature of a challenge response protocol is employed. This type of interchange passes at least one secret fresh random number from the server to the user equipment while also authenticating the user to the server. In this interchange, a first random number is distributed to the user for use in signing a document. A second random number is used by the user in forming a signature based on a hashing together of the first and second random numbers as part of the challenge response protocol. These numbers are supplied to the user equipment in encrypted form together with a freshness value. A signature by the server is created by hashing together the first and second random numbers and the freshness value.

### SUMMARY OF INVENTION

The present invention provides a very reliable and safe device for preventing access to equipment and/or information stored therein. The present invention also provide a device that can be combined with different units for both locking and identity input.

One advantage, among others, of the arrangement of the present invention as compared to known techniques is that (if applicable in a computer) no modification(s) of the operating system or the BIOS of the computer is needed. Such systems are easy to force, even without any greater knowledge within the area.

Furthermore, a lock unit according to the invention is integrated in the equipment to be protected, implying complete safety. Additionally, and by doing integrating the lock unit, the normal inputs and outputs of the equipment, such as the ports, etc., do not need to be modified.

These objects have been achieved by means of a security arrangement for securing access to a unit or information in a unit. The arrangement includes a key unit and lock unit, wherein the key unit is arranged some a distance from the lock unit. The key unit includes an input unit and a communication unit. Identification of a user is carried out in the key unit before locking/unlocking is accepted by the key unit.

### BRIEF DESCRIPTION OF DRAWINGS

In the following, the invention will be described with reference to the embodiments according to the enclosed drawings, in which:

FIG. 1 shows a block diagram over main parts of an arrangement according to the invention;

FIG. 2 shows a diagram over the communication between two units in the arrangement according to the invention;

FIG. 3 shows a block diagram over a first embodiment implementing an arrangement according to the invention in a computer unit;

FIG. 4 is a schematic side-view of a mobile communication unit provided with an arrangement according to the invention; and

FIG. 5 is a block diagram showing another aspect of the invention.

### DETAILED DESCRIPTION

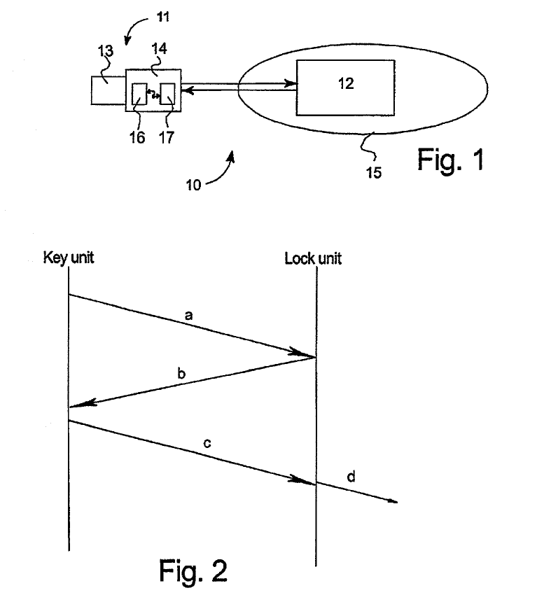

The device 10 according to the invention, schematically shown in FIG. 1, consists mainly of two units denoted with 11 and 12.

The first unit 11 includes a sensor or key part 11 for entering an identity, which performs an identification of the user. The key part 11 maybe divided in two units—an input unit 13 and a key unit 14, which preferably, but not necessarily, are integrated in one physical unit 11. The input unit 13 includes any type of arrangement by which a unique identification information can be entered. Such an arrangement can include a biometric sensor, PIN-code reader, voice detection device, eye detection device, card reader and so on, all well known to one skilled in the art.

The second unit includes a lock part or unit 12 for protecting the object 15 in question.

The key unit 14 initiates a unique communication procedure between the key part 11 and the lock part 12. Preferably, the identification of the user is carried out directly in the key part 11, and does not occur in the lock part.

After registration of a user, a corresponding lock can be opened. There are at least two ways or possibilities to maintain the lock open. According to one way, the lock is opened during a certain preselected time period. If the lock has been opened under a certain tune period, the user is requested to identify himself once more when the time has lapsed. In another manner, the lock may be kept “permanently” open (if manually chosen). This, however, results in poor safety.

When in operation, the identity is entered, e.g., by pressing the finger on a sensor (FPS), entering a PIN-code, etc. If the identification of the user is approved, an encrypted electronic message from the key unit to the lock unit is sent, whereby the locked resource or object 15 ( e.g., a hard disc in a computer) is made available for the user.

Using a secure transferring method between the units ensures that it is not possible to send a false message to the lock unit for procuring access to the locked unit.

The external unit, the key unit 14, is provided with electronics, which included a microprocessor 16 with a built-in and substantially protected program and data memory. The latter is provided as a precaution, enabling access to the program or stored key information for reading or copying.

Preferably, there is a list of allowed users stored in the key unit 14. Maintenance of this register, such as adding new approved users, deletion of users, etc., is carried out locally without communication with other units.

The key unit 14 decides at every occasion, if the object should be protected, should be opened, or should be locked. The decision is normally based on an operator/user decision, i.e., the key is initiated with allowed users. The locking may also occur on initiative of the lock unit 12 after a certain predetermined time. For example, should the operator, despite a request, not identify itself within a certain time, the unit can automatically lock.

The key unit 14 can be completely open and must not be protected against infringement, since the computer and data store cannot be externally read outside the processor (which is a security function in the processor).

The lock unit 12, which communicates with the key unit 14, e.g., via a serial connection, is mounted and protected on or in the object 15 to be locked. Each attempt to access the locked object by bypassing the normal login procedure through the key part 11 can be discovered or recognized by the lock unit 12. Alternative steps can also be initiated, i.e., inactivity for a longer time period, warning messages, erasing data on a hard disc/storage unit etc.

The communication between the key and the lock units is carried out by means of, e.g., digitally coded signals via a serial connection. The connection may be asynchronous, and may occur with a relatively high transfer rate. The communication occurs with a special lock protocol, which may also comprise known parity and time controls.

As mentioned, the purpose of the safety system according to the invention is, among others, to prevent unauthorized access to, for instance, computers, or more specifically, access to a certain hard disc and the information therein. To obtain almost complete security, an encrypted protocol can be used in the communication between the key part 11 and the lock part 12. The probability of successful infringement depends on the length of the random number, the protected length of the key and the length of the response. It may easily be made less than, for instance, 10⁻¹⁸, which practically means that it is safe for unauthorized access.

The lock protocol is a communication procedure ensuring computer integrity of the transmission. It also ensures that unauthorized infringement of the data exchange between the units cannot occur. If the message exchange is carried out correctly, the locked object is opened and stays open, respectively. If any errors should be detected, the object is locked.

For verifying authentication, the following message exchange may be used, diagrammatically illustrated in FIG. 2a. The key unit or the key code 14 starts a verification sequence by sending a request to the lock unit.

b. The lock unit 12 responds with a variable random generated message.

c. At the same time, a numerical value is calculated using a special algorithm utilizing a protected key. This value, which is completely derived from the response message sent out, is stored for later use.

d. The key unit 14 responds by calculating a numerical value from the received message using the same algorithm and key used in the lock unit 12. This number may be used unchanged in the response, or coded in such a way that the lock unit 12 can interpret it. If the lock unit 12 receives a message containing a number identical to the number calculated at the transmission during step b, the authentication is considered as confirmed.

If the message exchange turns out correctly, according to steps a-d above, the locked object is unlocked or remains open, respectively. If the response does not agree, the object remains locked.

The hidden key code may differ between the key and the lock unit (s) and between the lock units. This is possible because the key unit is initiated with additional information being specific for the connected lock unit, respectively. This enables the lock unit to return a correct response to the lock unit (as if it has access to the key code of the lock unit).

In a preferred embodiment, a biometric sensor unit is used as the input unit. Biometric sensors present considerable advantages, including identification of persons at entrance, computer access, etc. Other advantages include the speed, an extremely high degree of security for identification, and, also, no problems with forgotten passwords or password which have fallen into the wrong hands. In combination with the invention, the sensor part performs a biometric identification of the fingerprints of the user. When the identification of the fingerprints of the user is approved, an encrypted message is sent from the key unit to the lock unit, whereby the locked resource is made available to the user.

Registers of allowed fingerprints are in the key unit. Maintenance of this register, i.e., adding new approved fingerprints, removing fingerprints, etc., is done locally without any communication with other units.

The sensor unit can be provided with an indicator, such as two light-emitting diodes—a red one and a green one—for facilitating registration and deregistration of fingerprints. The diodes indicate whether the lock is closed or opened, and also the status of the registration/removal of fingerprints.

Following, a number of non-limiting examples are given, which clarify different aspects of the invention.

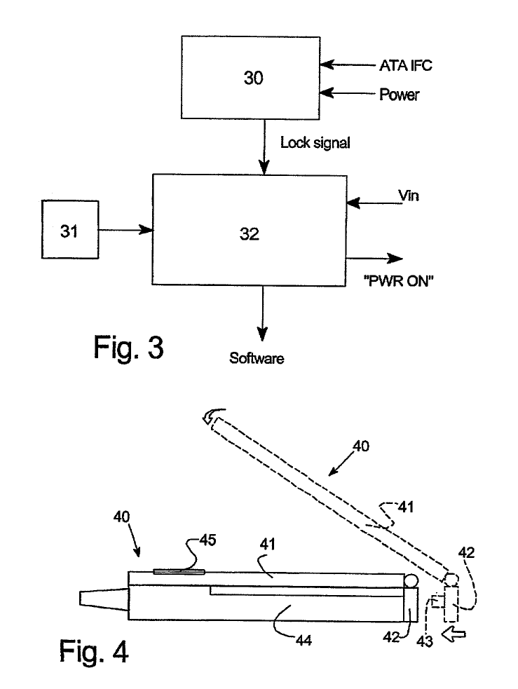

The first non-limiting example, shown in FIG. 3, relates to a hard disc unit 30 (or another memory unit or storage unit) in a computer unit provided with a fingerprint sensor 31 or a biometric sensor, i.e., an add-on unit. An add-on is one of many applications of the lock system according to the invention. An add-on unit can be a standard unit, such as a hard disc that has been provided with a lock unit and is connected to a computer unit (or the like) via a special electrical arrangement. The electronics can be located on, for instance, a controller board 32 (insert card to the computer, such as ISA, PCI, or the like). The electronics includes the key unit 11, as well as applications for communicating with the soft ware in the computer by way of a databus. A sensor 31 or, alternatively, other identification equipment, is connected to the board 32 either directly or via, e.g., IR or radio (Bluetooth) or the like.

In this preferred embodiment, a standard hard disc is modified to work together with the lock device according to the invention. This implies that it is provided with an internally mounted lock system for, through hardware, preventing the disc from accessing data. The appropriate procedure depends on the unit (disc) construction.

Connections to the unit are the same as to an ordinary hard disc, ie., signal cables and a power feed from the power unit of the computer. An additional connection for the communication of the lock with the controller is provided.

Lock-functions according to the invention are obtained by means of the key unit 11 and lock unit 12, respectively. The fingerprint sensor is connected through a cable and switched to the interface of the controller unit, on which the key unit is applied. The lock unit is arranged on the hard disc.

Except for lock functions, electronics for the communicating with the programs of the computer are arranged in the lock unit. The program can, among others, pre-warn about the locking of the hard disc. Moreover, the locking can be carried out from the software.

To restart the computer a switch is used, normally mounted on the front side. This is always energized (Vin=+5 V), even when the computer is shut off, provided that the main voltage is switched on. When switched on, a signal is provided to the motherboard and the computer is started. By using the fingerprint sensor, the switch can be disconnected and Vin, which is through the contact, is instead connected to the controller card. From there it is connected further to the fingerprint sensor. In this way the fingerprint sensor is always switched on. An approved log in gives a signal from the controller card to the motherboard replacing the ordinary button pressing.

Locking may be initiated in several ways:

automatically, when a certain amount of time has passed (e.g., in case of unauthorized manipulation);

when the user locks via the locking system; and

when the user locks with using a monitoring procedure, described below.

Unlocking can normally be carried out in one way, namely, by providing a correct fingerprint.

If the person(s) who has registered his fingerprint is not available when the disc must be unlocked, it is possible for, e.g., the system manager or the responsible security to unlock the unit by using a special code. This must be a sufficiently complicated code to prevent practically any access.

An attempt made to force lock by providing false signals to the bard disc, may result in locking it for further access attempts, for instance during a certain time period or until a responsible person has reset the lock function.

The fingerprint sensor may also be completed with other locking devices, for instance smart cards.

With the exception for previously enumerated functions, the add-on unit is completely compatible with a standard hard disc.

For installation of an add-on unit, special software can be required. This can supervise the lock function via a controller card and indicate the status for the user. In particular, the user must be warned in advance well before the disc is locked. With this program, it is also possible to directly lock the unit. Suitably, the program is always active and the status of the disc is shown in the system tray (activity field), where also different commands can be given.

Other applications for the system, according to the invention, include “Notebooks/Laptop”, i.e., portable computers, where all types of storing media are secured, HDD, FIDD, CD, RAM, ROM, flash memory, main controller board comprising all the components such as BIOS, controller units for controlling data media, etc.

In stationary computers/servers, the protection of the components on network cards and the like for administration of networks can be applied.

The system can be arranged as a remote control combined with a mobile telephone, as a code-provider unit. Data code generator for non-recurrent codes for accesses to computers, alarm systems, car locks, passage systems, etc.

Transaction codes via telephone systems, GSM, WAP or the like can occur. The unit. according to the invention, unlocks the unit and after that it is possible to choose the type of action.

In an application using the invention for bank transactions or the like via, e.g., a computer, the client may be provided with a sensor/key unit according to the invention. The client unit is provided with an embedded, unique PIN code and a special algorithm. The PIN code can be similar to the type used at credit or bankcard applications, but slightly advanced. The same PIN code can also be stored in the key unit being used by the client. The PIN code can be changed by means of special terminals on the bank. The same unique code can be associated with the account number of the client.

In the bank, when a transaction request is received a response is generated by means of a special calculation unit, which proves that the request from the correct key unit is authentic belonging to the right account holder.

The function may be described in more detail, according to the following steps

The client contacts the bank by means of a computer program installed in his computer and enters his account number

The bank issues a reply comprising an identification part, lock-data and so on,

The client selects the type of transaction and fills in the amount, and so on, and verifies the transaction,

The program transmits a locking transaction, according to the above description, and also transaction data comprising, for instance amount, account number, time stamp and so on,

A reply is received only if the lock unit has received the right identification from the key unit the response may comprise identity, variable locking/unlocking data and also transaction data, and is sent to the bank. The transaction data (for instance the sum) and authentication of the performer of the transaction is verified at the same time

The bank uses the algorithm, as mentioned above, together with the PIN code of the client for verifying the response, and if correct response can be urged of the incoming responses and transaction data, which assures that nothing has been changed after the biometry control, the transaction is accepted and the client is informed.

If the trade or transaction is carried out, for example, over the Internet, the user can be provided with a key unit arranged with, for instance, a biometric sensor or the like. The key unit of the user is provided with a unique identification in form of a check sum or the like. The same unique identification can be associated with the accounting number of the user at the bank. The bank is arranged with a controller or controlling means for verification of correct transaction request in the same way as above. In this case, the verification and the transaction are first performed by the bank and then to the seller, in the same way as above.

In one further example, the invention is used in a mobile unit, such as a mobile telephone, shown in FIG. 4. The security arrangement 40 consists of two pivoting parts 41 and 42 relative to each other (according to this example), where one part 42 includes a connector 43 for connecting to the communication port (not shown) of the telephone 44. The device includes a sensor unit 45, such as a biometric sensor or the like, and corresponding electronics and memory arranged on the second part 41. The electronics can be powered by the power source of the telephone. The connection part is connected to the telephone and the sensor part 41 is attached onto the backside of the telephone, for instance over its battery. When connected, the telephone can be used as a control or key unit, according to the above description.

The telephone can only be accessed if the right person verified via the sensor uses the telephone, which also can be used for controlling other units, for instance when payments over the telephone network, remote controlling, opening doors, access to computers (for instance via the IR interface), etc. In this case the lock unit can be implemented in the telephone.

Examples of other applications employing the invention include:

Radio add-on (RPR), ie., a memory unit, for instance a hard disc, provided with a biometric or transponder card reader; and

Lock unit for portable equipment (hand-held computers), only operating when a certain transponder is in the vicinity. The transponder can for instance be built in the wristwatch. In addition, the wristwatch may be provided with a biometric sensor communicating with the hand-held computer via IR or RF.

The lock device may be built inside a remote control for ensuring that only one authorized user can obtain access to the remote-controlled equipment.

When encrypting/decrypting, i.e., e-mails or files, encryption can be carried out by means of a public key while decryption by means of a private key being verified with regard to the right person using a biometric sensor.

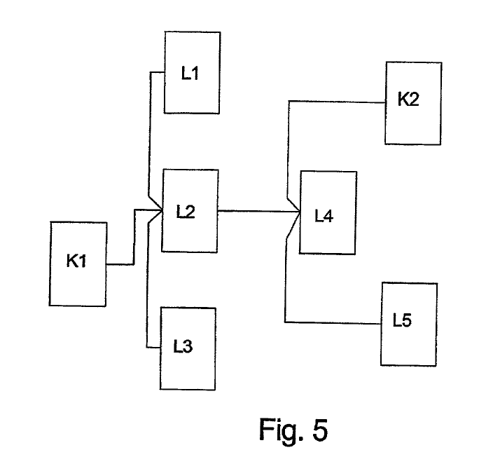

The invention is not limited to use of a key or lock unit, but combinations of several key and lock units where one or several key/lock units cooperate may also occur. The block diagram in FIG. 5 shows such arrangement, in which L₁-L₅ denote lock units and K₁ and K₂ denote key units. A key unit, for instance K₁ may be arranged to open a number of look units, for instance L₁-L₄ while K₂ opens L₄ and L₅. The term open means also access to different resources and information. The communication between lock units and between lock units and key units can be carried out via radio, Internet (or other networks), JR and so on, preferably decrypted according to the description above.

While only certain preferred embodiments of the invention have been illustrated and described, it is realized that several variations and modifications within the scope of the enclosed claims can occur.

1. A security arrangement for ensuring access to a unit or information in a unit by authenticating a user, said arrangement comprising:
a lock unit, and
a key unit arranged in communication with said lock unit, said key unit having an input unit, a communication unit and means for authentication of the user in the key unit before the key unit accepts locking/unlocking of said lock unit,
wherein said key unit is arranged to communicate with the lock unit by starting a verification sequence, upon said acceptance of locking/unlocking, by sending a request to said lock unit,
wherein said lock unit is arranged to respond by transmitting a variable, substantially randomly generated message, and
wherein a numerical value is calculated by means of an algorithm using a protected key stored in said lock unit, said numerical value being derived from the transmitted response message,
wherein said key unit is arranged to respond with a numerical value being calculated from the received message using said algorithm and said protected key, and
wherein, if said lock unit receives a message containing a value being identical to the value calculated by the lock unit, the authentication is confirmed.

2. The arrangement as claimed in claim 1, wherein said unit is selected from the grouping consisting of a computer, cash dispenser, door lock, car door, remote control, mobile communication unit, and portable computer.

3. The arrangement as claimed in claim 1, wherein said input unit is selected from the group consisting of a biometric sensor, PIN (Personal Identification Number) code reader, voice detection device, eye detection device, card reader, and mobile telephone.

4. The arrangement as claimed in claim 1, wherein the user identity is stored in the key unit.

5. The arrangement as claimed in claim 1, wherein said numerical value is used unchanged in the response.

6. The arrangement as claimed in claim 1, wherein said numerical value is encrypted so that the lock unit can interpret it.

7. The arrangement according to claim 1, said lock unit further comprising a memory unit in a computer unit, and said key unit further comprising a biometric sensor,
wherein said lock unit prevents access to data and is connected to the computer unit via a controller unit.

8. The arrangement according to claim 7, wherein said controller unit is selected from the group consisting of an ISA card and PCI card.

9. The arrangement according to claim 1, wherein said key unit further comprises a controller unit.

10. The arrangement according to claim 7, wherein said sensor unit is arranged to initiate said computer unit via said controller unit.

11. The arrangement according to claim 7, wherein a locking operation is automatically initiated after a certain time period has lapsed.

12. The arrangement according to claim 7, wherein a locking operation is automatically initiated by the user via the security arrangement.

13. The arrangement according to claim 7, wherein a locking operation is automatically initiated by the user using a security procedure.

14. A mobile communication unit provided with a security arrangement according to claim 1 for ensuring access to a unit or information in a unit,
wherein said security arrangement is an external unit connected to a communication port of said mobile communication unit,
wherein said security arrangement is provided with a biometric sensor connected to said communication unit,
said communication unit comprising either a key unit and/or a lock unit, and
wherein identification of a user is executed in the key unit before locking/unlocking is accepted by the lock unit.

15. Method of authentication in a security arrangement for ensuring access to a unit or information in a unit, the arrangement including a key unit and a lock unit, said key unit comprising an input unit and a communication unit arranged in communication with said lock unit, the method comprising the steps of:
initiating an authentication by said key unit upon initiation by a user,
initiating a verification by the key unit, upon authentication by said key unit, by sending a request to the lock unit,
responding by the lock unit with a varying, randomly generated message, calculating a numerical value simultaneously by means of a special algorithm using a protected key stored in said lock unit, and storing it for later use,
responding by the key unit with a numerical value being calculated from the message received, using said special algorithm and key used in the lock unit, and
confirming authentication if the lock unit receives a message containing a numerical value, which is identical to the one confirmed at the transmission during initiation of the verification by said key unit.

16. The method as claimed in claim 15, wherein said value is derived from the response message.
